(19) United States
(12) Patent Application Publication
(10) Pub. No.: US 2007/0264392 A1
(43) Pub. Date: Nov. 15, 2007

(54) Protein-Rich Baked Food and Process for Producing the Same

(75) Inventors: Daisuke Maejima, Niigata-Ken (JP); Shigeru Mineo, Niigata-Ken (JP)

Correspondence Address: LADAS & PARRY, 26 WEST 61ST STREET, NEW YORK, NY, 10023, US

(73) Assignee: BOURBON CORPORATION, Niigata (JP)

(21) Appl. No.: 10/580,665

(22) PCT Filed: Nov. 28, 2003
(86) PCT No.: PCT/JP03/15261

§ 371 Date: Mar. 27, 2007

(51) Int. Cl. A23L 1/304; A21D 13/00; A23C 21/00; A23D 7/00

(52) U.S. Cl. 426/74; 426/549; 426/583; 426/601

(57) ABSTRACT

This invention provides a high-protein baked food product, comprising at least: at least 15% by weight (on a dry weight basis), based on the whole food product, of a protein component; an oil and fat component and a saccharide component, wherein the high-protein baked food product is obtainable by finely grinding a first material mixture comprising a protein component, an oil and fat component, and a saccharide component, stirring the mixture to prepare a creamy primary product, mixing the primary product with a secondary material mixture provided separately from the primary product and comprising at least an oil and fat component and a saccharide component, and baking the mixture. This baked food product contains protein in a high concentration, is soft and has good chewability and dissolvability within the mouth.

### BACKGROUND OF THE INVENTION

1. Field of the Invention

The present invention relates to a baked food product that has a high protein content and is soft. More particularly, the present invention relates to a high-protein baked food product that can easily be eaten, for example, by aged persons and patients suffering from diseases who are difficult to eat hard food products and need efficient nutritional supplementation. The present invention also relates to a process for producing the high-protein baked food product.

2. Background Art

In many developed countries, the population is aging. For example, according to the results of the census conducted in 2000 in Japan, the proportion of aged persons of 65 years old or older in the population is 17% and is estimated to exceed 25% in 2015. It appears that this proportion surely increases in the future. It is known that, when an aged person is in such a state that swallowing and mastication are difficult, the aged person is likely to suffer from PEM (protein energy malnutrition). To cope with this, rich liquid food products with high nutrient balance and energy are commercially available for aged persons who suffer from the difficulty of swallowing.

Dialysis patients are generally in such a state that the renal function has been lost. Therefore, in the dialysis patients, the function of excreting excess mineral, waste products, water, etc. to be excreted in the kidney is lowered or lost. For this reason, dialysis patients are generally on diet therapy and have such a diet that minerals and water are limited. Further, it is said that about 30% of the dialysis patients are complicated by diabetes. Diabetes is a disease which causes a rise in his or her own blood glucose level. In this disease, suppression of a rapid rise in blood glucose level and control of blood glucose level are necessary.

To this end, it is desired that dialysis patients efficiently take good proteins.

Further, for example, it is said that, in Japan, at the present time, 197,000 patients undergo dialysis. About 35% of the dialysis patients are accounted for by aged persons of 65 years old or older.

High-protein nutritious food products are expected as food products for aged persons or dialysis patients.

Up to now, various high-protein nutritious food products have been developed. In many cases, they are, for example, soy proteins in such a form that the protein can be brought to a liquid state for eating. All of these high-protein nutritious food products are liquid and lack in convenience of nutritional supplementation, and, also from the appearance, it is difficult to say that these high-protein nutritious food products stimulate appetite.

Also for food products for babies and little children, those, which exhibit good digestion and absorption and have increased good protein content, have been developed. Such food products known in the art are in many cases liquid food products. However, for example, from the viewpoint of making a life habit of chewing to grow the jaw, nutritional food products having suitable hardness are required of food products for babies and little children.

When convenience of nutritional supplementation and eating feeling are taken into consideration, solid food products, for example, confectionary-like food products, are considered as high-protein nutritious food products. Such high-protein confectionery-like food products, however, have hardly been known so far as the present inventors know.

On the other hand, there are solid confectionery-like food products for general nutrition improvement purposes. For example, baked cookie-like food products are known as such food products.

In general, however, for baked food products, there is a tendency that the hardness of completed food products is enhanced with increasing the protein content. Such hard nutritious food products are unfavorable for aged persons who have weak physical strength and weak muscular strength and patients who have such a diet that minerals and water are limited. Such hard nutritious food products are unfavorable as food products for babies and little children. Further, food products having suitable softness generally tend to be preferred over hard food products.

Food products, which are solid high-protein nutritious food products and, at the same time, have hardness suitable for eating by aged persons, patients, etc., are not known so far as the present inventors know.

Accordingly, solid high-protein nutritious food products, which have soft food feeling and good chewability and dissolvability in the mouth, that is, can easily be eaten, for example, by aged persons, patients, and babies and little children, have been desired.

### SUMMARY OF THE INVENTION

The present inventors have now found that baked food products having a soft food feeling and good chewability and dissolvability within the mouth can be provided even in the case of baked food products having a high protein content, by finely grinding and stirring a protein component together with an oil and fat component and a saccharide component to give a creamy primary product, then mixing the primary product with a second material mixture comprising an oil and fat component and a saccharide component, and baking the mixture. The baked food products thus obtained have suitable hardness and are much softer than conventional high-protein baked food products and may have suitable softness depending upon purposes and applications. The present invention has been made based on such finding.

Accordingly, an object of the present invention is to provide a baked food product that has a high protein concentration, is soft, and has good chewability and dissolvability within the mouth.

According to one aspect of the present invention, there is provided a high-protein baked food product, comprising at least: at least 15% by weight (on a dry weight basis), based on the whole food product, of a protein component; an oil and fat component; and a saccharide component, wherein

said high-protein baked food product is obtainable by finely grinding a first material mixture comprising a protein component, an oil and fat component, and a saccharide component, stirring the mixture to give a creamy primary product, mixing the primary product with a secondary material mixture provided separately from the primary product and comprising at least an oil and fat component and a saccharide component, and baking the mixture.

According to another aspect of the present invention, there is provided a high-protein baked food product,

comprising at least: at least 15% by weight (on a dry weight basis), based on the whole food product, of a protein component; an oil and fat component; and a saccharide component, wherein

in a stress curve obtained by applying a tensipressor (diameter of plunger: 5 mm) to the baked food product, the maximum stress value is not more than 15 N.

According to a further aspect of the present invention, there is provided a process for producing a high-protein baked food product, comprising at least: at least 15% by weight (on a dry weight basis), based on the whole food product, of a protein component; an oil and fat component; and a saccharide component, said process comprising the steps of:

finely grinding a first material mixture comprising a protein component, an oil and fat component, and a saccharide component, and stirring the mixture to give a creamy primary product;

providing, separately from said primary product, a secondary material mixture comprising at least an oil and fat component and a saccharide component; and

mixing the primary product with the second material mixture and baking the mixture to give a high-protein baked food product.

As described above, the high-protein baked food product according to the present invention, despite its high protein content, is soft and has excellent chewability or dissolvability within the mouth. Therefore, the baked food product according to the present invention has good digestion absorption in the body and can realize efficient intake of protein in the body.

Accordingly, the baked food product according to the present invention can be advantageously used for nutritional supplementation purposes for aged persons, for example, aged persons who are short on physical strength and muscular strength, pregnant and parturient women, and postoperative patients, babies and little children, and further dialysis patients and the like. Since the baked food product according to the present invention is soft and has a certain food feeling, for example, the use of the baked food product for food products for aged persons can contribute to healing of the mind of the aged persons. Further, softness and a certain food feeling of the baked food product according to the present invention are also useful as afternoon snacks for babies and little children, for example, from the viewpoint of making a life habit of “chewing” for the development of the chin.

Further, in the baked food product according to the present invention, since the amounts of the components are previously learned, the baked food product can be used for properly and efficiently ingesting the protein. Therefore, this baked food product is also suitable as a diet food product for healthy persons.

### BRIEF DESCRIPTION OF THE DRAWINGS

FIG. 1A is a stress curve for a baked food product (baked food product 1) (present invention) measured for measurement No. 1 in Example.

FIG. 1B is a stress curve for a baked food product (biscuit H) (Comparative Example) measured for measurement No. 1 in Example.

FIG. 1C is a stress curve for a baked food product (biscuit S) (Comparative Example) measured for measurement No. 1 in Example.

### DETAILED DESCRIPTION OF THE INVENTION

High-Protein Baked Food Product

The high-protein baked food product according to the present invention comprises at least a protein component, an oil and fat component, and a saccharide component, wherein the protein component is contained in an amount of at least 15% by weight (on a dry weight basis), preferably at least 180% by weight; more preferably at least 20% by weight, based on the whole food product. In a more preferred embodiment of the present invention, the protein component is contained in an amount of 18 to 29% by weight, more preferably 21 to 24% by weight, based on the whole food product.

The term “baked food product” as used herein refers to food products produced by baking raw materials, and examples thereof include cookie-like food products such as cookies and biscuits; crackers; cakes; breads; and pretzels. Preferably, the baked food product according to the present invention is a cookie-like food product.

(i) Protein Component

In the present invention, the protein component may be an animal protein or a vegetable protein or a mixture thereof. Vegetable proteins include, for example, soy proteins, pea proteins, or wheat proteins. Animal proteins include whole milk powders, skim milks, whey proteins, milk proteins (for example, casein, albumin, and globulin), gelatin, egg white powders, egg yolk powders, or whole egg powders. They may be used either solely or in a combination of two or more.

In a preferred embodiment of the present invention, the protein component is a whey protein. The whey protein may be produced by a conventional method from raw milk or defatted milk. Alternatively, commercially available whey proteins as such may be used. Commercially available whey proteins include, for example, powdery whey protein concentrate (WPC), and highly purified whey protein isolates (WPIs). Highly purified whey protein isolates (WPIS) were commercially available, for example, from DAVISCO.

In a preferred embodiment of the present invention, in the protein component, the content of electrolyte components such as phosphorus, sodium, and potassium is low. More preferably, in the protein component, the content of phosphorus, the content of sodium, and the content of potassium each per g of the protein are not more than 2 mg, not more than 10 mg, and not more than 5 mg, respectively. When a protein of which the content of electrolyte components such as phosphorus, sodium, and potassium is a given value or less, is used, the rise in the amounts of these electrolytes in the body upon intake of ordinary food products can be avoided. Therefore, the baked food product prepared by using a protein component having a low electrolyte component content is suitable for nutritional supplementation purposes for renal failure patients and dialysis patients whom a limitation on the intake of mineral is imposed. When the protein has phosphorus, sodium, and potassium contents exceeding the above-defined range, a method may be adopted in which the protein is treated by ion exchange treatment or ultrafiltration treatment to lower the phosphorus, sodium, and potassium contents of the protein and the treated protein can be used for the baked food product.

In whey proteins commercially available as highly purified whey protein isolates (WPIs), the content of the electrolyte component in the protein is generally in the above-defined range. Accordingly, in a more preferred embodiment of the present invention, the protein component is a highly purified whey protein isolate (WPI).

(ii) Oil and Fat Component

In the present invention, the oil and fat component is not particularly limited so far as it is an edible oil and fat. Any of vegetable oils and fats, animal oils and fats, and processed oils and fats may be used. Specific examples thereof include vegetable oils and fats such as rape seed oils, soybean oils, cacao oils, corn oils, coconut oils, palm oils, safflower oils, cotton seed oils, sesame oils, olive oils, and rice oils; butter; beef tallow, margarines; and shortening. Preferred oil and fat components in the present invention are vegetable oils and fats and processed oils and fats such as shortening. They may be used in a combination of two or more.

The content of the oil and fat component in the high-protein baked food product is preferably 32 to 39% by weight, more preferably 34 to 37% by weight, based on the whole food product.

(iii) Saccharide Component

In the present invention, saccharine components include monosaccharides such as fructose and glucose, disaccharides such as sucrose and maltose, and oligosaccharides. Further, their reduced derivatives, for example, sugar alcohols, may be mentioned as the saccharide component. They may also be used in a combination of two or more.

In one preferred embodiment of the present invention, the saccharide component is a sugar alcohol. The sugar alcohol is less likely to be digested and absorbed in the small intestine and thus can advantageously suppress a rapid rise in blood glucose level. Sugar alcohols include, for example, sorbitol, xylitol, mannitol, erythritol, maltitol, and lactitol.

More preferably, the saccharide component is selected from the group consisting of sorbitol, xylithol, and a mixture thereof. When sorbitol and xylithol are used as the saccharide component instead of sucrose and the like, the intake of sugar in the body can be suppressed. Therefore, sorbitol and xylithol can be advantageously used for the prevention of diseases such as diabetes or nutritional supplementation for patients suffering from such diseases.

Further, in the present invention, sweeteners may be used instead of or in combination with the saccharide component from the viewpoint of imparting sweet taste to high-protein baked food products. Such sweeteners include, for example, stevia, glycyrrhetinic acid, aspartame, saccharin, acesulfam K, sucralose, licorice, thaumatin, and Momordica grosvenori extract.

(iv) Nutritive Function Enhancing Component

The high-protein baked food product according to the present invention may further comprise a nutritive function enhancing component from the viewpoint of improving nutritional balance to promote health. Such nutritive function enhancing components include, for example, calcium components, iron components, vitamins, and dietary fibers. Preferred nutritive function enhancing components include calcium components and/or iron components.

(a) Calcium Component

Calcium components in the form of, for example, calcium carbonate, calcium phosphate, calcium phytate, calcium oxalate, calcium lactate, eggshell calcium, unbaked calcium may be mentioned. When the high-protein baked food product further contains a calcium component, calcium can be ingested in an easy and efficient manner.

Calcium is generally a nutrient that is necessary for the formation of bones and teeth. However, for example, postoperative patients, aged persons, and pregnant and parturient women sometimes lack in calcium in the case of only calcium supplementation by ordinary food ingestion. Further, it is reported that, for example, for women of 70 years old or older, the average calcium adequacy is 92% (National Nutrition Survey in 2000 in Japan). Accordingly, high-protein baked food products having a higher calcium component content can be favorably used for nutritional supplementation for persons who are likely to lack or possibly lack in calcium, for example, postoperative patients, aged persons, and pregnant and parturient women.

The content of the calcium component in the high-protein baked food product is preferably 1.2 to 3.0% by weight, more preferably 1.4 to 1.6% by weight, in terms of the amount of only calcium based on the whole food product.

(b) Iron Component

Iron components in the form of, for example, ferrous gluconate, ferric chloride, iron citrate, ferric ammonium citrate, ferrous sodium citrate, iron lactate, sodium pyrophosphate, heme iron, and ferritin may be mentioned. When the high-protein baked food product further comprises the iron component, the iron component can be ingested in an easy and efficient manner.

Iron is generally a nutrient that is necessary for producing erythrocytes. Lack of iron component sometimes leads to iron deficiency or other problems. Accordingly, high-protein baked food products which further comprise an iron component can be favorably used for persons who exhibit symptoms of iron deficiency and the like, or nutritional supplementation for postoperative patients, aged persons, and pregnant and parturient women.

The content of the iron component in the high-protein baked food product is preferably 0.02 to 0.05% by weight, more preferably 0.025 to 0.030% by weight, in terms of only iron amount based on the whole food product.

(c) Other Nutritive Function Enhancing Component

Other nutritive function enhancing components include, for example, vitamins such as vitamin C, vitamin A, vitamin B1, vitamin B2, vitamin E, and vitamin B12; calcium pantothenate; nicotinamide; and cellulose.

(v) Powder Component

The high-protein baked food product according to the present invention may further comprise a powder component. The powder component refers to cereal powders and starches. Cereal powders include, for example, wheat flours, corn flours, rice powders, barley flours, rye flours, oats powders, leguminous crop powders, and buckwheat flours. Starches include, for example, wheat starches, potato starches, tapioca starches, corn starches, and rice starches. Chemically modified starches produced, for example, by etherifying, acetylating, crosslinking or pregelatinization of the starch may also be used as the starch. These powder components may also be used in a combination of two or more.

The content of the powder component in the high-protein baked food product is not particularly limited. Preferably, however, the content of the powder component in the high-protein baked food product is 2 to 13% by weight, more preferably 4 to 5% by weight, based on the whole food product.

(vi) Other Components

The high-protein baked food product according to the present invention may further optionally contain an egg or an egg-derived component.

The high-protein baked food product according to the present invention may further contain a perfume, a colorant, a seasoning component, a stabilizer, an expanding agent, sodium bicarbonate, ammonium carbonate, a baking powder, etc.

For example, seasoning components include cocoa powders, condensed milks, fresh creams, yoghurt powders, cheeses, chocolates, cacao masses, sesames, herbs, fruit juices, vegetable juices, dry fruit powders, fruit pieces, powdered green teas, spices, and nuts.

These other components may also be used in a combination of two or more.

Production process of high-protein baked food product The high-protein baked food product according to the present invention may be produced as follows.

Step a-1:

A protein component, an oil and fat component, and a saccharide component are first provided. They are mixed together to prepare a first material mixture.

In this case, the amount of the protein component used is such that the content of the protein component in the whole baked food product as a final product is at least 15% by weight (on a dry weight basis) (based on the whole baked food product). The content of the oil and fat component in the first material mixture is preferably 27 to 35% by weight (on a weight basis based on the whole first material mixture) from the viewpoint of finely grinding the first material mixture.

The first material mixture is then finely ground until the particle diameter of the first material mixture components is brought to not more than 50 μm at the largest, preferably about 18 to 25 μm. The fine grinding may be carried out, for example, by a refiner (manufactured by Buhler).

The finely ground first material mixture is then stirred under heating (for example, at 40 to 60° C.) optionally while adding the oil and fat component for creaming to give a creamy primary product.

Step a-2:

Separately form step a-1, a second material mixture comprising at least an oil and fat component and a saccharide component is provided.

Specifically, an oil and fat component is provided separately from step a-1 and is stirred. A saccharide component is added to the oil and fat component, and, if necessary, an egg and a powder component are successively added, followed by stirring to give a second material mixture.

Step b:

The primary product prepared in step a-1 is melted by heating (for example, at 40° C.), and, if necessary, a perfume is added to the melt. The melt is mixed with the second material mixture produced in step a-2, and the mixture is if necessary molded, followed by baking, for example, at 140 to 170° C. Thus, a high-protein baked food product according to the present invention can be produced.

Accordingly, the high-protein baked food product according to the present invention is produced by finely grinding a first material mixture comprising a protein component, an oil and fat component, and a saccharide component, stirring the mixture to give a creamy primary product, mixing the primary product with a secondary material mixture provided separately from the primary product and comprising at least an oil and fat component and a saccharide component, and baking the mixture.

In general, conventional baked food products are produced by stirring an oil and fat component, if necessary successively adding other components, for example, a protein component, a saccharide, an egg, and a powder component, stirring the mixture to give a dough, and baking the dough, or by mixing an oil and fat/saccharide, a protein component, an egg, and a powder component together at a time to give a dough and baking the dough. The production process of a high-protein baked food product according to the present invention is characterized in that, unlike the conventional production process in which other raw material components are merely added to a stirred oil and fat component, a creamy primary product is first produced using a protein component and an oil and fat component and is then added to the other raw material components. That is, the present invention is characterized in that the high-protein baked food product is produced by a two-stage process including the step of forming a creamy primary product. It is considered that, in the production process of the present invention, the adoption of the two-stage process can realize the production of food products having properties unattainable by the prior art technique, that is, baked food products having good softness and chewability and dissolvability in the mouth.

The high-protein baked food product according to the present invention is produced through the above production steps. If necessary, after baking, the food product may be further processed. For example, after baking, chocolate, cream or the like may be coated on the food product, or alternatively may be inserted into the food product. Accordingly, the baked food product according to the present invention embraces baked food products subjected to such conventional processing.

Amino Acid Score

In a preferred embodiment of the present invention, the high-protein baked food product according to the present invention has an amino acid score of 100.

The term “amino acid score” as used herein refers to an index that indicates whether or not the protein in a food product satisfies the human essential amino acid requirement, and has been calculated based on an amino acid scoring pattern published by a joint committee of Food and Agriculture Organization (FAO), World Health Organization (WHO), and United Nations University (UNU). In the present invention, the amino acid score is based on an adult scoring pattern established in 1985.

Specifically, the “amino acid score” may be calculated as follows. At the outset, the proportion of the amounts of amino acids in an object protein to essential amino acid requirements in an amino acid scoring pattern shown in Table A below (an adult scoring pattern established by the joint committee of FAO, WHO, and UNU in 1985) is calculated in percentage for each amino acid. The lowest value among the values obtained respectively for the amino acids is regarded as the amino acid score of the object protein. In this case, when all the essential amino acids exceed the respective requirements of the scoring pattern, that is, all the calculation results for the amino acids exceed 100%, the amino acid score is 100.

TABLE A
Amino acid scoring pattern

| | Amount of amino acid |
|---|---|
| Essential amino acid | (mg/g-protein) |
| Histidine | 16 |
| Isoleucine | 13 |
| Leucine | 19 |
| Lysine | 16 |
| Methionine + cystine | 17 |
| Phenylalanine + tyrosine | 19 |
| Threonine | 9 |
| Tryptophan | 5 |
| Valine | 13 |

The amino acid score of the protein contained in the baked food product according to the present invention may be determined, for example, by analyzing a sample for amino acids contained in a protein, for example, by the following method and determining the amino acid score based on the results of the analysis. The protein referred to herein includes all the proteins contained in the baked food product according to the present invention. Specifically, for example, not only the above protein component-derived protein but also protein derived from optionally used eggs or powder component such as wheat flour is contained. The amino acid analysis may be carried out, for example, by the following method. A protein-containing sample is first hydrolyzed by an acid or an alkali to decompose the protein into amino acids and thus to prepare a sample solution. This sample solution is analyzed for various amino acids with a high performance liquid chromatograph using a reversed-phase partition column and with an amino acid automatic analyzer with a cation exchange column connected thereto utilizing a ninhydrin color development method, and the amounts of various amino acids can be quantitatively determined based on the chromatograms.

The protein having an amino acid score of 100 contains satisfactory amounts of essential amino acids and thus can be said to be a nutritionally ideal protein. When a food product containing this protein is used, the protein of which the ingestion is preferred can be ingested efficiently. Accordingly, this food product may be preferably used for nutritional supplementation for patients suffering from diseases and aged persons.

In the present invention, the amino acid score in the high-protein baked food product can be set to 100 by properly selecting the type of the protein component and the amount of the protein component used.

Hardness and Chew Work of High-Protein Baked Food Product

For the high-protein baked food product according to the present invention, in a stress curve obtained by applying a tensipressor (diameter of plunger: 5 mm) to the baked food product, the maximum stress value is typically not more than 15 N, preferably 5 to 14 N, more preferably 9 to 12.5 N.

The expression “stress curve obtained by applying a tensipressor (diameter of plunger: 5 mm) to the baked food product” as used herein refers to a curve showing a change in stress with the elapse of time obtained by measuring the hardness of the baked food product with a tensipressor (for example, Tensipressor: MODEL TTP-50BX, manufactured by TAKETOMO ELECTRIC) and a plunger for use in this tensipressor having a diameter of 5 mm for penetration elasticity measurement under conditions of load cell 10 kg and a sample table travel speed 60 mm/min.

Further, the term “maximum stress value” as used herein refers to the maximum value of stress in the stress curve and is an index for indicating the hardness of the baked food product. The smaller the maximum stress value of the food product, the softer the food feeling.

In a preferred embodiment of the present invention, the chew work of the high-protein baked food product, that is, the initial work necessary for starting chewing of the food product, is not more than 2.0×10⁻³ J, more preferably 1.0×10⁻³ to 1.9×10⁻³ J, still more preferably 1.1×10⁻³ to 1.8×10⁻³ J.

The expression “chew work of food product” as used herein refers to the work of the plunger in a period between the start of measurement, that is, the start of contact of the food product with the plunger and 0.5 sec after the start of contact of the food product with the plunger in the “stress curve.” Specifically, in the above stress curve, the work can be determined by integrating the stress curve in its part up to 0.5 sec. The smaller the chew work value, the softer the food feeling of the start of chewing of the food product and the better the dissolvability in the mouth. Therefore, the food product according to the present invention can be said to have excellent chewability and dissolvability in the mouth.

### EXAMPLE

The present invention is further illustrated by the following Example that is not intended as a limitation of the invention.

### Production Examples

Baked food product 1 (present invention) and biscuit H (Comparative Example) and biscuit S (Comparative Example) were produced as follows.

Baked Food Product 1 (Present Invention)

The baked food product according to the present invention (baked food product 1) was produced using raw materials according to formulations specified in Table 1 below by the production process according to the present invention. In the following description, the term “% by weight” refers to % by weight based on the whole baked food product as a final product.

Specifically, at the outset, 22.6% by weight of a protein component (a whey protein), 19.9% by weight of an oil and fat component (a palm oil or a corn oil), and 16% by weight of a saccharide component were provided and were mixed together to prepare a first material mixture. The first material mixture was then finely ground with a refiner so that the maximum diameter of the resultant particles was not more than 25 μm. The oil and fat component (8.0% by weight) was additionally added to the fine particles under heating conditions of 40 to 60° C., and the mixture was stirred for creaming to prepare a creamy primary product.

On the other hand, 8.9% by weight of a separately provided oil and fat component was stirred, and 16% by weight of sugar alcohol, 3.3% by weight of a hen's egg, 5% by weight of wheat flour, and 0.3% by weight of perfume were successively added to the oil and fat component, and the mixture was stirred to prepare a second material mixture.

Next, the above primary product was melted under heating (40° C.). Perfume was added to the melt, and the mixture was added to the above second material mixture, followed by stirring. The mixture was molded, and the molded product was baked in an oven of 165° C. for 11.5 min to give baked food product 1.

The baked food product 1 was analyzed for amino acids by an amino acid automatic analyzer (JLC-300, manufactured by Japan Electric Optical Laboratory) and by high performance liquid chromatography (LC-10 AS, manufactured by Shimadzu Seisakusho Ltd.) to determine an essential amino acid level. An amino acid scoring pattern was used based on this value for evaluation. As a result, the amino acid score of the protein contained in this baked food product 1 was 100.

Biscuit H (Comparative Example)

Hard-type biscuit H as Comparative Example was produced using raw materials according to a formulation specified in Table 1 below.

Specifically, all the materials shown in Table 1 were introduced into a mixer at a time, and the mixture was kneaded for one hour ten minutes. After kneading, the biscuit dough thus obtained was molded, and the molded product was baked in an oven of 240° C. for 5 min to give biscuit H.

Biscuit S (Comparative Example)

Soft-type biscuit S as Comparative Example was produced using raw materials according to a formulation specified in Table 1 below.

Specifically, butter, edible oil and fat, perfume, and an emulsifier shown in Table 1 were mixed together, and the mixture was stirred. Sugar was added thereto, and the mixture was further stirred. A hen's egg and wheat flour were successively mixed thereinto to prepare a biscuit dough. The biscuit dough thus obtained was molded, and the molded product was baked in an oven of 190° C. for 13 min to give biscuit S.

TABLE 1

| | Baked food | Biscuit | Biscuit |
|---|---|---|---|
| Component | product 1 | H | S |
| Wheat flour | 5.0 | 63.9 | 48.8 |
| Protein component (whey protein) | 22.6 | | |
| Sugar | | 17.5 | 20.8 |
| Sugar alcohol | 32.0 | | |
| Butter | 6.6 | 1.0 | 4.9 |
| Oil and fat component (edible | 30.2 | 10.7 | 19.6 |
| oil and fat) | | | |
| Hen's egg | 3.3 | | 5.0 |
| Milk | | 5.2 | |
| Salt | | 0.5 | 0.6 |
| Expanding agent | | 1.0 | 0.1 |
| Emulsifier | | | 0.05 |
| Perfume | 0.3 | 0.2 | 0.15 |

(All the values in the table are in % by weight)

Evaluation Test:

Baked food product 1, biscuit H and biscuit S produced above were subjected to the following hardness measuring test to evaluate the hardness and the chew work.

At the outset, for each of baked food product 1, biscuit H, and biscuit S, a stress curve was prepared using a tensipressor as a texture measuring device under the following conditions.

Tensipressor: MODEL TTP-50BX (manufactured by TAKETOMO ELECTRIC)

Plunger: for penetration elasticity measurement, diameter 5 mm

Load cell: 10 kg

Sample table travel speed: 60 mm/min

For each sample, the measurement was carried out five times.

Test A: Maximum Stress Value

The maximum stress value was determined from the prepared stress curve, and the average value of data on the five measurements was determined for each food product.

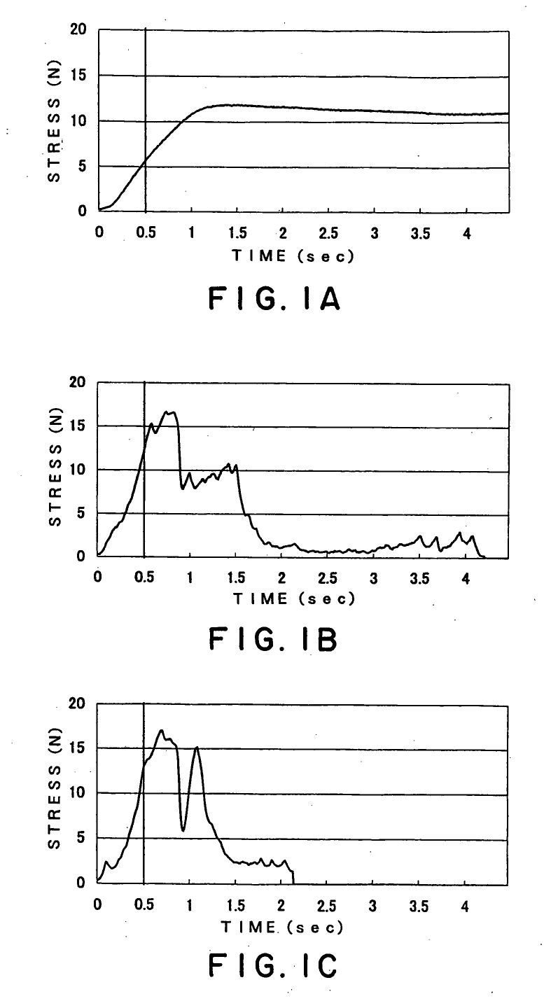

The results were as shown in Table 2 below. Further, for each food product, a stress curve in the first measurement was shown in FIG. 1.

TABLE 2
Maximum stress value

| | | Biscuit H | Biscuit S |
|---|---|---|---|
| Measurement | Baked food | (Comparative | (Comparative |
| No. | product 1 | Example) | Example) |
| 1 | 11.87 | 16.67 | 17.06 |
| 2 | 10.00 | 17.06 | 18.44 |
| 3 | 10.69 | 16.57 | 17.75 |
| 4 | 12.16 | 16.48 | 16.18 |
| 5 | 9.41 | 16.08 | 17.26 |
| Average | 10.83 | 16.57 | 17.34 |

(All the values in the table are in N (newton))

Comparison of average values of the maximum stress values shows that the average value for the present invention was much smaller than the average value for Comparative Examples. That is, the baked food product according to the present invention had suitable softness as compared with the conventional food products.

Evaluation B: Chew Work

For each food product, the chew work was determined and evaluated using the above stress curve. The chew work of the food product refers to the work of the plunger and was calculated by determining the integral value of the stress curve in a period between the start of the measurement and 0.5 sec after the start of the measurement.

The results were as shown in Table 3 below.

TABLE 3
Chew work (work of plunger)

| | | Biscuit H | Biscuit S |
|---|---|---|---|
| Measurement | Baked food | (Comparative | (Comparative |
| No. | product 1 | Example) | Example) |
| 1 | 1.25 × 10⁻³ | 2.53 × 10⁻³ | 2.26 × 10⁻³ |
| 2 | 1.71 × 10⁻³ | 2.29 × 10⁻³ | 3.52 × 10⁻³ |
| 3 | 1.36 × 10⁻³ | 2.35 × 10⁻³ | 2.46 × 10⁻³ |
| 4 | 1.29 × 10⁻³ | 2.24 × 10⁻³ | 2.28 × 10⁻³ |
| 5 | 1.32 × 10⁻³ | 2.43 × 10⁻³ | 3.82 × 10⁻³ |
| Average | 1.39 × 10⁻³ | 2.37 × 10⁻³ | 2.87 × 10⁻³ |

(All the values in the table are in J)

Comparison of the chew work for each food product shows the chew work for the present invention was much smaller than that for Comparative Examples. That is, the baked food product according to the present invention was much superior in chewability to the conventional food products.

1. A high-protein baked food product, comprising at least:
at least 15% by weight (on a dry weight basis), based on the whole food product, of a protein component;
an oil and fat component; and
a saccharide component,
wherein said high-protein baked food product is obtainable by finely grinding a first material mixture comprising a protein component, an oil and fat component, and a saccharide component, stirring the mixture to give a creamy primary product, mixing the primary product with a secondary material mixture provided separately from the primary product and comprising at least an oil and fat component and a saccharide component, and baking the mixture.

2. The high-protein baked food product according to claim 1, wherein said protein component is a highly purified whey protein isolate (WPI).

3. The high-protein baked food product according to claim 1, wherein the amino acid score based on an adult amino acid scoring pattern is 100.

4. The high-protein baked food product according to any one of claim 1, wherein said saccharide component is a sugar alcohol.

5. The high-protein baked food product according to claim 4, wherein said sugar alcohol is selected from the group consisting of xylitol, sorbitol, and a mixture thereof.

6. The high-protein baked food product according to any one of claim 1, which further comprises a trophicity enhancing component.

7. The high-protein baked food product according to claim 6, wherein said trophicity enhancing component is a calcium component and/or an iron component.

8. The high-protein baked food product according to any one of claim 1 wherein, in a stress curve obtained by applying a tensipressor (diameter of plunger: 5 mm) to the baked food product, the maximum stress value is not more than 15 N.

9. The high-protein baked food product according to any one of claim 1, wherein, in the application of a tensipressor to a high-protein baked food product under conditions of plunger diameter 5 mm and sample table travel speed 60 mm/min, the chew work of the food product, determined as a plunger work in a period between the start of contact of the food product with the plunger and 0.5 sec after the start of contact of the food product with the plunger is not more than 2.0×10⁻³ J.

10. The high-protein baked food product according to any one of claim 1, which is a cookie-like food product.

11. The high-protein baked food product according to any one of claim 1, wherein said protein component is contained in an amount of 18 to 29% by weight (on a dry weight basis) based on the whole food product.

12. The high-protein baked food product according to any one of claim 1, wherein said oil and fat component is contained in an amount of 32 to 39% by weight (on a dry weight basis) based on the whole food product.

13-20. (canceled)

21. A process for producing a high-protein baked food product, comprising at least:
at least 15% by weight (on a dry weight basis), based on the whole food product, of a protein component;
an oil and fat component; and
a saccharide component, said process comprising the steps of:
finely grinding a first material mixture comprising a protein component, an oil and fat component, and a saccharide component, and stirring the mixture to prepare a creamy primary product;
providing, separately from said primary product, a secondary material mixture comprising at least an oil and fat component and a saccharide component; and
mixing the primary product with the second material mixture and baking the mixture to give a high-protein baked food product.

22. The process according to claim 21, wherein the stirring of the first material mixture is carried out under heating conditions.

23. The process according to claim 21, wherein said oil and fat component is contained in an amount of 27 to 35% by weight, on a weight basis based on the whole first material mixture, in the first material mixture.

24. The process according to claim 21, wherein the second material mixture is prepared by adding a saccharide component to the stirred oil and fat component and further stirring the mixture.

25. The process according to claim 21, wherein the mixing of the primary product with the second material mixture is carried out by mixing the primary product, which has been heated and melted, with the second material mixture.

26. The process according to claim 21, wherein said protein component is a highly purified whey protein isolate (WPI).

27. The process according to claim 21, wherein said saccharide component is a sugar alcohol.

28. The process according to claim 21, wherein, in a stress curve obtained by applying a tensipressor (diameter of plunger: 5 mm) to the high-protein baked food product, the baked food product has a maximum stress value of not more than 15 N.

29. The food product according to claim 21, wherein said protein component is contained in an amount of 18 to 29% by weight (on a dry weight basis) based on the whole food product.

30. The food product according to claim 21, wherein said oil and fat component is contained in an amount of 32 to 39% by weight (on a dry weight basis) based on the whole food product.
